(19) United States
(12) Patent Application Publication
(10) Pub. No.: US 2015/0134965 A1
(43) Pub. Date: May 14, 2015

(54) Enhanced Secure Virtual Machine Provisioning

(71) Applicants: Fredric Morenius, Solna (SE); Christian Gehrmann, Lund (SE); András Méhes, Sundbyberg (SE)

(72) Inventors: Fredric Morenius, Solna (SE); Christian Gehrmann, Lund (SE); András Méhes, Sundbyberg (SE)

(73) Assignee: Telefonaktiebolaget L M Ericsson (publ), STOCKHOLM (SE)

(21) Appl. No.: 14/399,393

(22) PCT Filed: May 24, 2012
(86) PCT No.: PCT/EP2012/059768

§ 371 Date: Nov. 6, 2014

(51) Int. Cl. H04L 29/06; G06F 9/455

(52) U.S. Cl. CPC H04L 63/0435; G06F 9/45533; H04L 63/0807
USPC 713/172

(57) ABSTRACT

In a method of provisioning a virtual machine (VM) to a computing network (401), a VM manager or provisioner (403, 408) encrypts a virtual machine using a key bound to at least one security profile indicative of one or more security requirements that a computing resource (402) of the computing network (401) must satisfy in order to be able to decrypt the VM. A key for use in decrypting the VM has previously been sealed into multiple (and preferably into all) computing resources (402) in the network into which the VM is to be provisioned, and has been sealed such that a computing resource can obtain the key only if it is in a state that satisfies the security profile, or at least one security profile, to which the key is bound The VM manager or provisioner (403, 408) creates a VM launch package that includes the encrypted VM and that also includes a key that may be used in decrypting the encrypted VM. When the VM launch package is received at a computing resource (402), the computing resource will not be able to recover the key for use in decrypting the VM—and hence will be unable to decrypt the VM—unless the computing resource satisfies the security requirements indicated by the security profile. The VM manager or provisioner can thus be sure that the VM will not be launched on a computing resource that does not meet the desired security profile. Alternatively the VM manager or provisioner (403, 408) may send a token corresponding to a desired security profile with an encrypted VM. A computing resource uses the token to obtain a key to decrypt the VM but the computing resource will not be able to recover the key unless the computing resource satisfies the security requirements indicated by the token.

### TECHNICAL FIELD

The present invention relates to a method of provisioning a virtual machine (VM), for example to a method of provisioning a virtual machine (VM) that provides a user with improved control over the security of the VM.

### BACKGROUND

In past years there has been a strong move in the market place towards usage of virtualization technologies. Virtualization allows one to run legacy applications unmodified on new hardware platforms. This is realized through on-the-fly translation from one hardware instruction set to another with the assistance of a so-called hypervisor or Virtual Machine Monitor (VMM). A hypervisor runs in the most privileged mode in a system and has full control over vital system re-sources. A hypervisor-based system not only allows instruction translation, but above all, increased system utilization as multiple Virtual Machines (VMs) can run simultaneously on a single powerful hardware platform, opening for new business models and a new business landscape. This implies for example that existing services can rather easily be migrated into large computing clusters or what often is referred to as the cloud.

The cloud model where the customer is allowed to run a complete virtual machine (including operating system), is often referred to as Infrastructure as a Service (IaaS) using cloud terminology.

This new flexibility has a price: increased security risks. Systems that previously were physically isolated from one another might now run on the same machine and consequently this opens up the possibility of new attacks between virtual machines running simultaneously on the same hardware. The hypervisor or VMM is a new target for attacks. Once a VMM is compromised, the whole system is compromised. Hence, it is very important to make sure that the all security critical components including the VMM are trusted prior to launching a service on a platform. It is also important to consider, from a security perspective, that protection mechanisms implemented on operating system (OS) or application level utilizing specific hardware capabilities/features might become vulnerable when the actual hardware is virtualized.

The Trusted Computing Group (TCG) [http://www.trustedcomputinggroup.org/] has defined mechanisms for making integrity measurements of software blocks and to securely report them into a special purpose hardware module, the Trusted Platform Module (TPM). These mechanisms can be used by an external verifier to get a signed report on the current “state” of a platform from the TPM and to also “seal” secret values into a particular platform state. Trusted computing technologies are important potential enablers for protecting virtual environments.

Virtualization as such is a well established technology and has been used in different type of systems the past 40 years. The current dominating VMM solutions are VMWare [http://www.vmware.com/products/esx/index.html], Xen, and KVM (Kernel-based Virtual Machine) [http://www.linux-kvm.org/page/Main Page].

A new protocol for creating a trusted channel between a client and server through combining Transport Layer security (TLS) has been proposed. This solution binds a certain TLS connection to a trusted target platform software configuration.

A solution for secure management of virtualized resources was proposed in US patent application 2010/0125855 focusing on mutual authentication and security policy handling aspects.

A process for secure boot of a VMM including integrity measurement and remote attestation of a VMM and OS was suggested in US patent application 2010/0023743. The remote attestation method follows in principle the standard process as described by the TCG.

IaaS can be realized through solutions provided by professional providers such as IBM and Amazon. Several open source projects also work with developing software enabling technologies that can be used to build IaaS service. Examples of such projects are OpenStack by Nova Concepts [http://nova.openstack.org/nova.concepts.html], CloudStack [http://cloudstack.con/], Eucalyptus [http://www.eucalyptus.com], and OpenNebula [http://opennebula.org/].

Existing solutions to the problems of launching a VM may have their own problems, and these will be explained with reference to FIG. 1 which is a schematic block diagram of typical architecture of IaaS network model. FIG. 1 illustrates the Nova architecture and uses the Nova terminology, but the architecture shown in FIG. 1 shares its main characteristics with any IaaS cloud architecture and the invention is not limited to this particular architecture.

In the network architecture of FIG. 1, an IaaS network 10 (for example a “computing cloud”) includes a plurality of computer controllers 6 that can run jobs supplied to the network 10. The network is controlled by a controller (the “cloud controller”) 4. A scheduler 5 assigns each job received in the network to one of the computer controllers 6. The network may also contain an object store 7—if, for example, a job is received in the network before the time when the user requires the job to be executed it may be stored in the object store 7. The network may also contain an “Auth Manager” 8 for managing credentials, a network controller 11, and a volume control 9 (which controls a detachable block storage device, known as a “volume”).

In the architecture of FIG. 1, a VM Management Client (VMMC) (not shown) is responsible for launching and controlling VMs through well defined API(s) (Application Programming Interface(s)), for example through an API server 3. There are two major different principles for launching a VM:

1). The VMMC transfers a VM image it has prepared itself through the API to the cloud controller 4 that is then responsible for launching the VM on a suitable computer controller 6.

2). The VMMC selects a suitable VM image for launch, which may be prepared by some other party. Typically the VM image is already provided in the cloud network (for example in an object store 7).

In the following description, we refer to the first model where the VMMC itself is responsible for the VM as “model 1”. However, in some business models, the second principle implies that the VMMC chooses between VM images prepared by the IaaS or some other provider and not by the VMMC. In the following description, we refer to this model as “model 2”. The present invention may be applied to either of these models, and there is no significant difference between application of the invention to the first model and application to the second model as long as the VMMC in model (1) is responsible for preparing and uploading the VM image to be used in the IaaS cloud 10.

In general, three principal phases are required to achieve a VM running on a computing resource in the IaaS network 10 of FIG. 1, namely:

A) creating the VM;

B) deploying the VM to the IaaS network (this is referred to a “provisioning” the VM into the network; and

C) launching the VM on a computing resource in the IaaS network.

As explained above, phase (C) of launching VM is controlled by a VMMC. The cloud controller 4 and scheduler 5 of the network of FIG. 1 are responsible for, at the instruction of the VMMC, selecting a computing resource to run a VM and launching a VM that a client deploys/has already deployed in the system. The actual virtual computing resources are the computer controller nodes 6 where VMs are running on behalf of the VM management clients.

Phases (A) and (B) are carried out by entities acting, respectively, as a “VM provider” and a “VM provisioner”. It should however be understood that it is not necessary for the “VM provider”, the “VM provisioner” and the VMMC to be three separate entities, and two or more of phases (A) to (C) may be carried out by the same entity. For example, in model 1 above the VMMC may also acts as the VM provider and the VM provisioner.

It should also be noted that phase (C) of launching the VM may be carried out upon completion of phase (B) of provisioning the VM into the network. Alternatively, the VM may be stored in the network 10 once it has been provisioned into the network, and in phase (C) is subsequently retrieved from storage and launched.

The principle for model 1 VM launching, for the example of the network architecture of FIG. 1, is illustrated in FIG. 2. The VM management client 1 transfers a VM image 2 to the cloud controller 4 via an API server 3—that is, the VMMC carries out the provisioning phase, phase B. (The VMMC may also have created the VM, or in principle the VMMC may have received the VM from a separate VM provider.) The VMMC then instructs launch of the VM. The cloud controller 4 then forwards the VM to the scheduler 5. The scheduler 5 is responsible for choosing a suitable computer controller 6-1, 6-2, 6-N to launch the VM. This method of launching a VM implies that, when the VMMC 1 transfers the VM to the cloud infrastructure and instructs launch of the VM, the VMMC will not know exactly which computer controller 6-1, 6-2, 6-N will run the VM.

The principle for model 2 VM launching is illustrated in FIG. 3, again for the example of the network architecture of FIG. 1. Here the VMMC 1 selects a pre-stored VM image 2′ for launch which already exists at the IaaS provider (for example stored in object store 7), or which is uploaded to the IaaS provider by a VM provider in time for the VMMC to initiate launch of the VM 2′. In this method, the VMMC 1 instructs the launch phase, phase C, by sending an indication that it would like to launch a pre-stored VM 2′, and this indication is passed to the cloud controller 4 via the API server 3. The cloud controller 4 retrieves the VM 2′ from the object store 7, and forwards the VM to the scheduler 5. The scheduler 5 is again responsible for choosing a suitable computer controller 6-1, 6-2, 6-N to launch the VM. Again, the VMMC 1 will not know exactly which computer controller 6-1, 6-2, 6-N will run the VM, so that direction communication between the VMMC and computer controller 6-1, 6-2, 6-N which is selected to run the VM is not possible during the VM launch. Furthermore, since the VMMC may be launching a VM that was not created by the VMMC, the VMMC may not know whether the VM is trustworthy.

For both model 1 and 2, this invention addresses how to solve the problem of how VM images are bound to a trusted computer controller (what we will refer to as computer controller) or resource. The mechanisms for this binding need to be different/more flexible still allowing for reasonable security with respect to target platform integrity.

For model 2, this invention addresses how to solve the problem of ensuring VMMC trust in VM images provided by a VM provider other than the VMMC itself.

### SUMMARY

A first aspect of the invention provides a method of provisioning a virtual machine (VM) to a computing network. The method comprises encrypting a virtual machine at a VM manager or provisioner, using a first key bound to a desired security profile. The security profile is indicative of one or more security requirements that a computing resource of a computing network must satisfy in order to be able to decrypt the VM. The encrypted VM is then sent from the VM manager or provisioner to the computing network.

The term “provisioning a VM to a computing network” as used herein refers to the process of deploying a VM into the computing network, for example into an IaaS network such as the network of FIG. 1 or FIG. 4. For the avoidance of doubt, “provisioning a VM” does not include creation of the VM, or launching/instructing launch of the VM on a computing resource in the network.

The phrase “encrypting a virtual machine . . . using a first key” is intended to cover a case where the first key is directly used to encrypt the VM and also to cover a case where the first key is used indirectly in encryption of the VM (such as, for example, where the VM is encrypted with a key that is not the first key, and the first key is then used to encrypt the key used to encrypt the VM).

The security profile may directly indicate the security requirement(s) that a computing resource of a computing network must satisfy in order to be able to decrypt the VM, or it may indirectly indicate the security requirement(s) that a computing resource must satisfy in order to be able to decrypt the VM (for example by defining hardware and/or software properties that, if possessed by a computing resource, will lead to the computing resource satisfying the security requirements).

As described in more detail below, a key for use in decrypting the VM has previously been sealed into multiple computing resources (and preferably into all computing resources) in the network into which the VM is to be provisioned. The key has been sealed into the computing resources against one or more desired security profiles, so that a computing resource can obtain the key only if it is in a state that satisfies the security profile, or that satisfies at least one of the security profiles, to which the key is bound.

The phrase “key for use in decrypting the VM” is intended to cover a case where the key is directly used to decrypt the VM (eg, where the first key has been directly used to encrypt the VM) and also to cover a case where the key is used indirectly in decryption of the VM (for example, where the first key has been used to encrypt another key used to encrypt the VM, the key for use in decrypting the VM may be used to recover the another key which may then be used to decrypt the VM).

The VM manager or provisioner creates a VM launch package that includes the encrypted VM and that also includes a key that may be used in the process of decrypting the encrypted VM. When the VM launch package is received at a computing resource, the computing resource will not be able to recover the key for use in decrypting the VM—and hence will not be able to decrypt the encrypted

VM included in the VM launch package—unless the computing resource satisfies the security requirements indicated by the security profile to which the first key has been bound. The VM manager or provisioner can thus be sure that the VM will not be launched on a computing resource that does not meet the desired security profile.

The encrypted VM may be sent to an IaaS provider for immediate launching, in the manner described with reference to FIG. 2. Alternatively, the encrypted VM may be sent to an IaaS provider for storage, with the VM being launched subsequently, in the manner described with reference to FIG. 3.

It should be noted that a key used to encrypt the VM may be bound against two or more different security profiles. The key may be bound individually against two or more security profiles, and in this case a computing resource that satisfies at least one of the security profiles against which the key has been bound is able to obtain the key and so decrypt the VM. Alternatively the key may be bound recursively against two or more security profiles, and in this case only a computing resource that satisfies all the security profiles against which the key has been recursively bound is able to obtain the key and so decrypt the VM. Accordingly, specifying that the first key is “bound to a desired security profile” does not require that the first key is bound to only a single security profile, and specifying that the first key is “bound to a desired security profile” should be interpreted as meaning that the first key is bound to at least one desired security profile.

It should also be noted that the VM may be encrypted with more than one key, with each key being bound against a respective security profile. In this case, a computing resource is required to obtain each key with which the VM has been encrypted before it can decrypt the VM, and this requires that the computing resource must satisfy each respective security profile to which a key has been bound.

For simplicity however, the invention will mainly be described with reference to embodiments in which the VM is encrypted with one key.

The VM manager or provisioner may encrypt the virtual machine using a second key, and encrypt the second key using the first key. For example, the VM may be encrypted using a symmetric key, and the symmetric key may then be encrypted using a public key of a public-private key pair (with the public key having been bound against the security profile). A VM typically includes a large amount of data, and it may therefore require significant encryption resources to encrypt the entire VM using a public key of a public-private key pair. Encrypting the VM using a symmetric key and then encrypting the symmetric key using a public key of a public-private key pair provides greater security than if only a symmetric key were used, while requiring considerably fewer resources than encrypting the entire VM using a public key of a public-private key pair. When the VM is received at a computing resource having the desired security profile, the computing resource is able to obtain the first key, and can then use the first key to decrypt the second key and so decrypt the VM.

The VM manager or provisioner may send a request for a key, with the request including the desired security profile, to a key provider trusted by the VM manager or provisioner. The trusted key provider either binds a key against the security profile when it receives the request and sends the key to the VM manager or provisioner, or it has pre-bound keys that it can send to the VM manager or provisioner in response to the request. Thus, the VM manager or provisioner receives the first key, bound against the security profile included in the request sent by the VM manager or provisioner, from the trusted key provider in response to the request.

Alternatively, the VM manager or provisioner may itself generate the first key—that is, the VM manager or provisioner may itself also act as the trusted key provider

A second aspect of the invention provides a method of provisioning a virtual machine (VM) to a computing network. In this method a VM manager or provisioner encrypts a virtual machine using a key. The VM manager or provisioner then sends the encrypted VM to a computing network, with a token that corresponds to a desired security profile indicative of one or more security requirements that a computing resource of the computing network must satisfy in order to be able to decrypt the VM. The encrypted VM and the token may be sent to an IaaS provider, either for immediate launching of the VM or for the VM to be stored for a subsequent launch.

This aspect of the invention provides a method that is in many ways similar to, and is complementary to, the method of the first aspect of the invention. This aspect of the invention is however suitable for use with a symmetric key (that is a key which can be used in both encryption and decryption), whereas the first aspect uses an asymmetric key (that is where one key is used in encryption and a different key is used in decryption), The VM package sent in the second aspect includes a token that a recipient of the package can use to obtain a key with which they may decrypt the VM package (provided that they meet the security requirements indicated in the security profile).

Similarly to the first aspect, specifying that the token corresponds to “a desired security profile” does not require that the token corresponds to only a single security profile, and the token may correspond to two or more, different security profiles. Specifying that the token corresponds “to a desired security profile” should therefore be interpreted as meaning that the token corresponds to at least one desired security profile. Where a token corresponds to two or more security profiles, in one example a recipient of the package that satisfies at least one of the security profiles may be able to obtain the key and so decrypt the VM. Alternatively, in another example only a recipient of the package that satisfies that satisfies all the security profiles is able to obtain the key and so decrypt the VM.

When the encrypted VM is received at a computing resource, the computing resource uses the token to obtain a key to decrypt the VM. However, the computing resource will not be able to obtain a key to decrypt the VM unless it satisfies the security requirements indicated by the security profile to which the token corresponds. The VM manager or provisioner can thus again be sure that the VM will not be launched on a computing resource that does not meet the desired security profile.

The VM manager or provisioner may obtain the key and the token from a trusted key provider in response to the VM manager or provisioner sending a request including the desired security profile to the trusted key provider. Alternatively, the VM manager or provisioner may itself generate the key and the token (in a case where the VM manager or provisioner also acts as a trusted third party).

In a case where the VM manager or provisioner acts as a trusted third party and generates the key and the token, the VM manager or provisioner will, once the token has been received at a computing resource selected to launch the VM, receive the token from the computing resource. The VM manager or provisioner may then determine whether the computing resource satisfies the security requirements indicated by the security profile to which the token corresponds and, if it does, send the key to the computing resource. (If the VM manager or provisioner does not determine that the computing resource satisfies the security requirements indicated by the security profile to which the token corresponds, the VM manager or provisioner does not send the key to the computing resource.)

The VM manager or provisioner may create the VM. Alternatively, the VM manager or provisioner may receive the VM from a VM provider.

The security profile may define a target set of computing resources. Thus, if the VM manager or provisioner is aware of a particular set of computing resource that it considers is sufficiently secure to be used for launching a particular VM, the VM manager or provisioner may specify a security profile that indicates security requirements that are satisfied by all computing resources of this set. The VM manager or provisioner will be assured that the VM will be launched on a computing resource of the desired set (or on a computing resource that has the same security profile as a computing resource of the desired set.)

A third aspect of the invention provides a method of activating a virtual machine (VM). In this method a computing resource receives a token corresponding to a security profile indicative of one or more security requirements that the computing resource must satisfy in order to be able to decrypt the VM, and sends the token to a key provider (for example to a key provider identified by/in the token). If the computing resource satisfies the security requirements indicated by the security profile, it will receive a key from the key provider in response to the sending of the token to the key provider, and the computing resource can then use the received key to decrypt the VM.

If however the computing resource does not satisfy the security requirements indicated by the security profile it will not receive a key, and so cannot decrypt the VM. As noted for the second aspect, specifying that the token corresponds to “a desired security profile” does not require that the token corresponds to only a single security profile. Specifying that the token corresponds “to a desired security profile” should be interpreted as meaning that the token corresponds to at least one desired security profile.

A method of the third aspect is complementary to a method of the second aspect, but defines the steps carried out at a computing resource rather than at a VM manager/provisioner.

Once the computing resource has decrypted the VM it can then launch the VM.

The computing resource may receive the VM with token. Alternatively, the computing resource may receive the VM after the computing resource has received the key.

A fourth aspect of the invention provides a method carried out at a key provider. The method comprises receiving, from a virtual machine (VM) manager or provisioner, a request for a token corresponding to a desired security profile for launching a VM, the security profile being indicative of one or more security requirements that a computing resource of a computing network must satisfy in order to be able to decrypt the VM. The key provider generates a key and a token corresponding to the desired security profile, or retrieves a pre-existing key and token corresponding to the desired security profile, and sends the key and the token to the VM manager or provisioner. Subsequently, the method comprises receiving the token from a computing resource, and determining whether the computing resource satisfies the security requirement(s) associated with the token. If the computing resource satisfies the security requirement(s) associated with the token, the method comprises sending the key to the computing resource.

If the computing resource does not satisfy the security profile associated with the token, the key is not sent to the computing resource.

A method of the fourth aspect is complementary to a method of the second or third aspect, but defines the steps carried out at a key provider rather than at a computing resource or a VM manager/provisioner. In this aspect, the VM manager or provisioner has used the key and token sent to it by the key provider to secure a VM as described in the second aspect above. The token has been received at a computing resource which has been selected to launch the VM, and the computing resource now requires the key provider to send the key to the computing resource as described in the third aspect above.

As with the second and third aspects, specifying that token corresponds to “a desired security profile” does not require that the token corresponds to only a single security profile. Specifying that the token corresponds “to a desired security profile” should be interpreted as meaning that the token corresponds to at least one desired security profile.

The key provider may generate first and second keys, and generate the token using the first key. It may then send the second key and the token to the VM manager or provisioner.

The key provider may, upon receipt of token from the computing resource, use the first key to verify the token.

A fifth aspect of the present invention provides a network entity configured to provision a virtual machine (VM) to a computing network. The network entity comprises a processor and memory storing programming instructions that, when executed by the processor, cause the network entity to encrypt a virtual machine using a first key bound to a desired security profile indicative of one or more security requirements that a computing resource of a computing network must satisfy in order to be able to decrypt the VM, and send the encrypted VM from the network entity to the computing network.

It should be noted that, while the network entity that is responsible for provisioning a VM into the network can always be considered to be acting as a “provisioner”, the network entity may not be titled a “provisioner” but may have another title such as “VM manager” or “VMMC”.

The network entity may be configured to encrypt the virtual machine using a second key, and to encrypt the second key using the first key.

The network entity may be configured to obtain the first key from a trusted key provider in response to the network entity sending a request including the desired security profile to the trusted key provider.

The network entity may be configured to generate the first key.

A sixth aspect of the present invention provides a network entity configured to provision a virtual machine (VM) to a computing network. The network entity comprises a processor and memory storing programming instructions that, when executed by the processor, cause the network entity to encrypt a virtual machine using a first key, and send, from the network entity to a computing network, the encrypted VM and a token corresponding to a security profile indicative of one or more security requirements that a computing resource of the computing network must satisfy in order to be able to decrypt the VM.

The network entity may be configured to send a request including the desired security profile to a trusted key provider to thereby obtain the key and the token.

The network entity may be configured to generate the key and the token.

The network entity may be further configured to receive the token from a computing resource, and determine whether the computing resource satisfies the security requirement(s) indicated by security profile to which the token corresponds. If the computing resource satisfies the security profile associated with the token, the network entity may send the key to the computing resource.

The network entity may further configured to create the VM.

The network entity may further configured to receive the VM from a VM provider.

The security profile may define a set of target computing resources.

A seventh aspect of the present invention provides a computing resource configured to receive a token corresponding to a security profile indicative of one or more security requirements that the computing resource must satisfy in order to be able to decrypt a virtual machine (VM), and send the token to a key provider. The computing resource is further configured to, if the computing resource satisfies the security requirement(s), receive a key from the key provider and, using the received key, decrypt the VM at the computing resource.

The computing resource may be further configured to launch the VM.

The computing resource may be configured to receive the VM with the token. Additionally or alternatively the computing resource may be configured to receive the VM after receiving the key.

An eighth aspect of the present invention provides a network entity. The network entity comprises a processor and memory storing programming instructions that, when executed by the processor, cause the network entity to receive, from a virtual machine (VM) manager or provisioner, a request for a token corresponding to a desired security profile for launching a VM, the security profile being indicative of one or more security requirements that a computing resource of the computing network must satisfy in order to be able to decrypt the VM, generate or retrieve a key and a token corresponding to a desired security profile, and send the key and the token to the VM manager or provisioner. The instructions further cause the network entity to receive the token from a computing resource, and determine whether the computing resource satisfies the security requirement(s) associated with the token. The instructions further cause the network entity to, if the computing resource satisfies the security requirement(s) associated with the token, send the key to the computing resource.

The network entity may be configured to: generate first and second keys, generate the token using the first key, and send the second key and the token to the VM manager or provisioner.

The network entity may be configured to, upon receipt of token from the computing resource, use the first key to verify the token.

In the fifth to eighth aspects, the security profile may define one or more properties that the computing resource must possess in order for the computing resource to satisfy the one or more desired security requirements.

In the fifth aspect, specifying that the first key is “bound to a desired security profile” does not require that the first key is bound to only a single security profile, and specifying that the first key is “bound to a desired security profile” should be interpreted as meaning that the first key is bound to at least one desired security profile.

In the sixth to eighth aspects, specifying that token corresponds to “a desired security profile” does not require that the token corresponds to only a single security profile. Specifying that the token corresponds “to a desired security profile” should therefore be interpreted as meaning that the token corresponds to at least one desired security profile.

For both model 1 and 2, this invention addresses how to solve the problem of how VM images are bound to a trusted computer resource (for example a computer controller as shown in FIGS. 2 and 3). The mechanisms for this binding need to be flexible in allowing use of any suitable computing resources, while still allowing for reasonable security with respect to target platform integrity.

Alternatively/additionally, for model 2, this invention addresses how to solve the problem of ensuring VMMC trust in VM images provided by a VM provider other than the VMMC itself.

Co-pending patent application PCT/SE2011/050502, describes a method on how to securely launch a VM on a specific cloud platform through a combination of remote attestation and usage of the TCG sealing mechanism. This method allows, given that there is a direct channel between the VM management client and the cloud infrastructure target platform, to protect the VM end-to-end from the management client to the target platform at VM launch. This method was later extended in co-pending patent application U.S. Ser. No. 13/275722 to also protect the VM at migration. Hence, the combination of these two methods provides methods for protecting the VM both at the launch occasion and during migration.

However, as explained above, the conventional methods of launching a VM imply that, when, for example, the VMMC 1 of FIG. 2 transfers the VM to the cloud infrastructure (ie, to the IaaS network), the VMMC will not know exactly which computer controller 6-1, 6-2, 6-N will run the VM. Consequently, it may not be possible to apply the launch principles described in PCT/SE2011/050502—in model 1 the VMMC 1 will not know exactly which computer controller 6-1, 6-2, 6-N will run the VM, so no direct communication actually takes place between the VMMC and the computer controller 6-1, 6-2, 6-N that runs the VM. This is also the case for model 2—in both model 1 and model 2 the scheduler 5 and/or network controller 4 select one of the available computer controllers 6-1, 6-2, 6-N to run the VM, and the VMMC is not involved in the selection of a computer controller.

As discussed above, this invention addresses two distinct problems:

A. Ensuring VMMC trust in VM images provided by another party.

B. VM image binding to a computer controller.

To address problem A, a Trusted VM Provisioner (TVMP) entity is, in one embodiment, introduced into the system. The role of the TVMP is to verify that a VM received from a VM provider is in such a state that it can be trusted by the VMMC not to behave maliciously in any way.

To address problem B, we propose a solution where a trusted third party entity (which may be the same entity as the TVMP) is introduced into the system that allows the VMMC or TVMP to seal a VM into a general instead of a particular computer controller. We suggest binding, for example cryptographically binding, the VM to this security profile or multiple security profiles at VM launch instead of the previous solutions proposed in PCT/SE2011/050502 or U.S. Ser. No. 13/275722 where the VM was bound to a particular platform with a particular trusted configuration at launch. This generic binding is done according to one of the following two different principles:

1. Prior to deploying a computer controller into the IaaS provider network, a shared secret private key (of a public-private key pair) is sealed to a trusted configuration corresponding to a particular security profile or profiles on the set of computer controllers that will be used in the system. (The key is referred to as a “shared” secret private key since it is sealed into multiple computer controllers.) A target computer controller which is selected to launch the VM can only access this private key if it boots into a trusted configuration corresponding to the particular security profile (or to one of the security profiles). When a VMMC is about to launch a VM on the IaaS cloud, or the TVMP is about to provision a VM to the IaaS cloud, the VMMC or TVMP first contacts the trusted third party in order to retrieve one or more public key(s), each corresponding to a specific security profile or profiles. The VMMC or TVMP then uses these public key(s) to protect the VM when launching or provisioning it to the IaaS cloud.

2. Prior to deploying a VM into the IaaS cloud, the VMMC or TVMP contacts the trusted third party in order to get a unique secret key and security token corresponding to a particular security profile or profiles. Next, the VMMC or TVMP uses this secret key to encrypt and integrity protect the VM that it is about to be launched or provisioned in the IaaS cloud. Before the protected VM is launched on the selected computer controller, the computer controller needs to contact the trusted third party and present the received security token (received together with the encrypted VM). Finally, the trusted third party directly verifies that the selected computer controller has been booted into a trusted state corresponding to one of the security profiles in the token. If that is the case, the secret key (used to protect the VM) is sent protected from the trusted third party to the selected computer controller, which uses the secret key to decrypt and verify the VM for launch. In this embodiment the secret key can be a symmetric key.

### BRIEF DESCRIPTION OF THE FIGURES

Preferred embodiments of the invention will be described with reference to the accompanying figures, in which:

FIG. 1 is a schematic illustration of an IaaS architecture;

FIG. 2 is a schematic illustration of one method of launching a VM over the IaaS architecture of FIG. 1;

FIG. 3 is a schematic illustration of another method of launching a VM over the IaaS architecture of FIG. 1;

FIG. 4 is a schematic illustration of a network architecture in which the present invention may be used;

FIG. 5(a) is a schematic illustration of sealing a key to a trusted configuration of a computing resource;

FIG. 5(b) is a schematic illustration of a method of launching a VM over an IaaS architecture according to one embodiment of the present invention;

FIG. 6(a) is a schematic illustration of sealing a key to a trusted configuration of a computing resource;

FIG. 6(b) is a schematic illustration of a method of launching a VM over an IaaS architecture according to another embodiment of the present invention;

FIG. 7 is a schematic illustration of a method of launching a VM over an IaaS architecture according to another embodiment of the present invention;

FIG. 8 is a schematic illustration of a method of launching a VM over an IaaS architecture according to another embodiment of the present invention;

FIG. 9 is a block flow diagram showing the principal steps of a method according to one embodiment of the present invention;

FIG. 10 is a block flow diagram showing the principal steps of a method according to another embodiment of the present invention;

FIG. 11 is a block flow diagram showing the principal steps of a method according to another embodiment of the present invention;

FIG. 12 is a block flow diagram showing the principal steps of a method according to another embodiment of the present invention;

FIG. 13 is a block diagram showing the principal components of a network entity according to an embodiment of the present invention; and

FIG. 14 is a block diagram showing the principal components of a computing resource according to an embodiment of the present invention.

### DETAILED DESCRIPTION

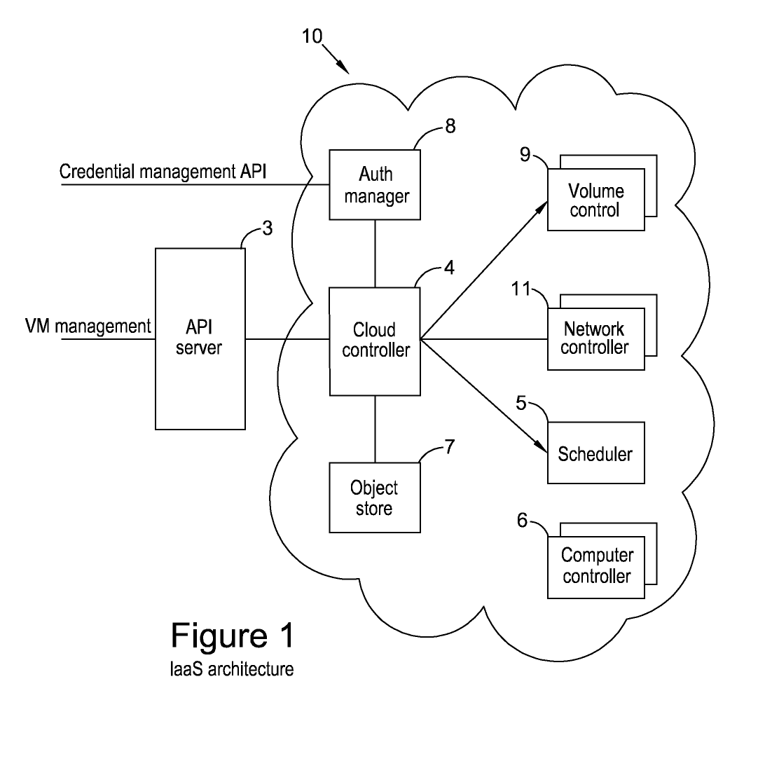

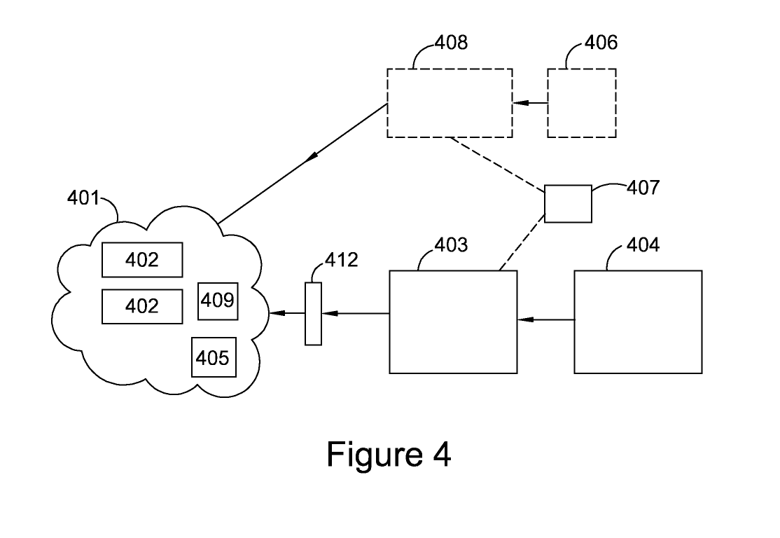

FIG. 4 is a schematic illustration of a network architecture in which the present invention may be used. Preferred embodiments of the invention will be described below with reference to this network architecture but, as noted above the invention may be carried out any suitable architecture, including without limitation the Nova architecture of FIG. 1. In general, the network architecture comprises a computing network 401 which contains a plurality of computing resources 402 and an object store 405. (Two computing resources 402 are shown in FIG. 4, but this is by way of example and in general there will be more than two computing resources. Similarly, the network may contain more than one object store.) Other features of the network 401 are not shown in FIG. 4.

The network 401 may for example be an IaaS provider network such as a computing cloud. A computing resource may in general be any computer or processor. Where the invention is implemented in the Nova architecture the computing resources 402 correspond to the computer controller nodes of FIG. 1 or, as a further example, where the invention is implemented in the Eucalyptus architecture the computing resources 402 correspond to the “node controller” of the Eucalyptus architecture.

The network also includes one or more controllers that are responsible for controlling operation of the network, including assigning each received job to a particular computing resource. These are indicated schematically in FIG. 4 by controller 409. (When the invention is applied in the Nova IaaS architecture, for example, the controller 409 of FIG. 4 may correspond to the cloud controller 4 and scheduler 5 of FIG. 1.)

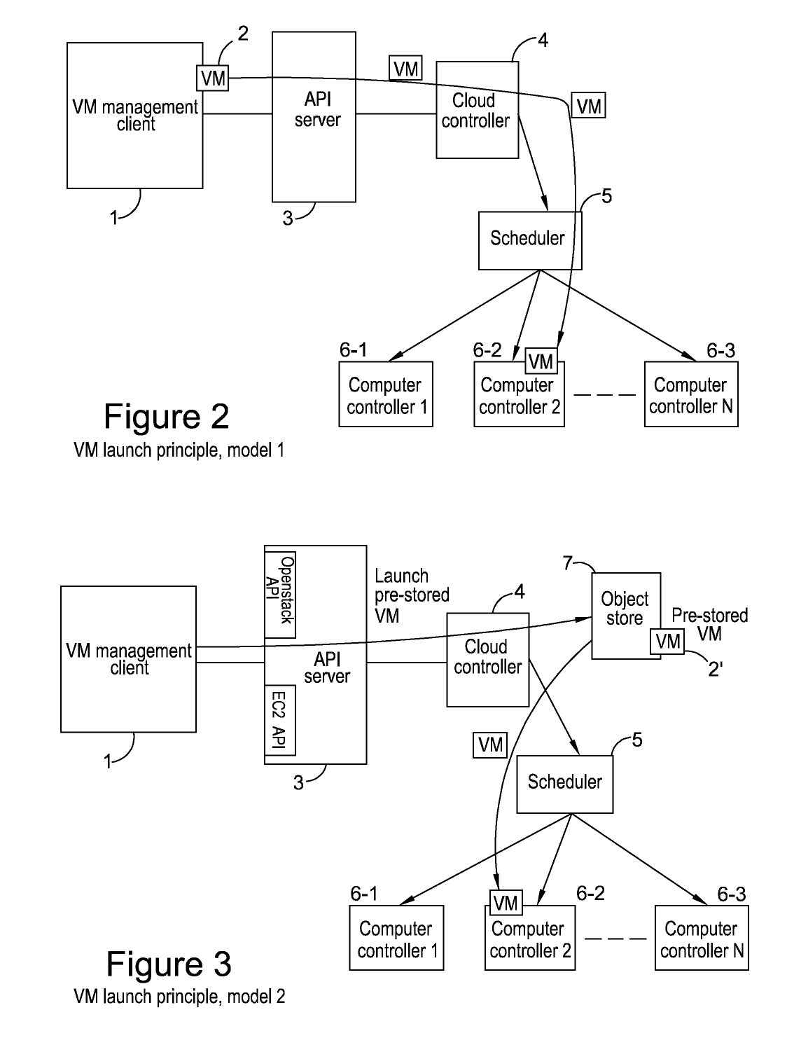

Entity 403 is a VM Manager Client (VMMC) that instructs the launching of VMs into the network 401 upon receipt of a request from a user 404, via an API 412. The VMMC 403 may launch the VM directly on one of the computing resources 402 of the network (as shown in FIG. 2), or the VMMC may instruct launch of a VM that has previously been stored in an object store 405 in the network (as shown in FIG. 3).

The VMMC may create VMs (in which case the VMMC may create a VM, provision that VM into the network 401, and instruct launch of the VM). Alternatively, the network architecture may optionally include a Trusted VM Provisioner (TVMP) 408 that receives a VM from a separate VM provider 406s, verifies a received VM, and (assuming the verification is satisfactory) provisions the VM into the network 401. A VM provisioned into the network 401 by the TVMP 408 may be stored in an object store 405 in the network (from where it may subsequently be launched onto a computing resource of the network under a further instruction from the VMMC 403). (The VM provider 406 and TVMP 408 are not required if the VMMC 403 is able to create VMs and provision them into the network and so are shown in broken lines.

That is, there are three principal actions involved in setting a VM running on a computing resource 402 of the network 401—creating the VM, provisioning the VM into the network, and instruct launching of the VM. The VMMC 403 may carry out all three actions itself. Alternatively the VMMC may carry out only the final action, with the VM provider 406 creating the VM and the TVMP 408 provisioning the VM into the network.

The entity that provisions a VM into the network—that is, either the VMMC 403 or the TVMP 408—may communicate with a trusted third party 407 that can generate one or more keys when requested by the VMMC or TVMP. In FIG. 4 the trusted third party 407 is shown as a separate entity from the VMMC and TVMP but in principle the trusted third party 407 may be included within the VMMC or within the TVMP as appropriate.

The computing network 401 is able to handle an encrypted VM, for example is able to schedule an encrypted VM to one of the computing resources 402.

FIG. 4 shows the user 404 and the VM provider 406 outside the network 401. The invention is not limited to this, and the user 404 and/or the VM provider 406 could alternatively be within the network 401.

As discussed above, this invention addresses one or both of two distinct problems:

A) ensuring that a VM image is bound to one or more trusted computing resources so that the VM will be launched only a trusted computing resource, even in the absence of knowledge as to which particular computing resource the VM will be launched on; and

B) ensuring that a VMMC can trust VM images provided by another party.

To address problem B, a Trusted VM Provisioner (TVMP) entity may be introduced into the system, that is entity 408 of FIG. 4. The TVMP may provision a VM into an object store 405 in the network 401, from where the VM may subsequently be launched on a computing resource of the network 401 by the VMMC 403. The role of the TVMP is to verify that a VM received from a VM provider such as VM provider 406 is in such a state that it can be trusted by the VMMC not to behave maliciously in any way.

To address problem A, we disclose below a solution where a trusted third party entity 407 (which as noted may be the same entity as the VMMC or TVMP) is introduced into the system. This allows the VMMC or TVMP to bind a VM that it is going to provision into the network to one or more general security profiles instead of binding the VM to a particular platform with a particular trusted configuration at launch as in the previous solutions proposed in PCT/SE2011/050502 or U.S. Ser. No. 13/275722. Optionally, the VM may be cryptographically bound to this security profile or multiple security profiles at VM launch.

A security profile indicates one or more security requirements that a computing resource 402 of the computing network 402 must satisfy in order to be able to decrypt the VM. For example, a security profile may specify software and/or hardware properties that shall be in effect for each considered logical or physical component of a computing resource 402 in order for the computing resource 402 to satisfy a certain set of security requirements. The invention is not however limited to this, and the security profile may indicates the one or more security requirements in any suitable way. The security requirements may for example be defined by the trusted third party 407. Where a VM is bound to more than one different security profiles, different security profiles may specify different software/hardware properties and consider different components. A single security profile may encompass a whole set of software/hardware properties, i.e., not just a single software configuration instance. A result of this is that computing resources with different hardware and software configurations may be part of the same security profile.

As noted, a VM may be bound to one security profile, or to multiple security profiles. The mechanism by which a VM is bound to the security profile(s) can be such that either a single security profile or a combination of different security profiles must be satisfied by a computing resource in order to be able to decrypt and launch the VM.

The generic security profile binding may done according to one of the following two different principles:

(a) Prior to deploying a computing resource into the network 401, a key is sealed into the computing resource against one or more security profiles. The key is the decryption key of an asymmetric key pair, and advantageously is the private key of a public key-private key pair (a public key-private key pair is an asymmetric key pair in which the private key cannot readily be derived from knowledge of the public key). The sealing is effected through interaction between the computing resource and a trusted third party. The effect of the sealing is that the computing resource can only access the key if it is in a state that satisfies the security profile, or at least one security profile, to which the key has been bound. One suitable protocol for sealing the key into the computing resource is defined by the Trusted Computing Group, and according to the TCG model the computing resource binds a public-private key pair to one (or more) security profiles so that the computing resource can access the private key only when it is in a trusted state that corresponds to the profile (or to at least one of the profiles). This is often referred to as a “bound private-public key pair”. The trusted third party verifies the bound key (typically through an attestation key from the TPM of the computing resource) in the sealing process, and after this verification the trusted third party encrypts the private key by the public bound key of the computer resource. When a VMMC is about to launch a VM on the network 401 (for example onto an IaaS cloud), or a TVMP is about to provision a VM to the network 401, the VMMC or TVMP first contacts the trusted third party in order to retrieve one or more key, for example the public key(s) of one or more public-private key pairs, each key corresponding to a specific security profile or profiles. The VMMC or TVMP then uses these key(s) to protect the VM when launching or provisioning the VM to the network 401 (eg to the IaaS cloud). When the VM is received at a computing resource for launch, the computing resource is required to use the key that was previously sealed into the computing resource in order to decrypt the VM—however, the computing resource can access this key only if it satisfies the security requirements corresponding to a trusted configuration associated with the security profile(s) against which the key has been sealed. The TVMP or VMMC can thus be sure that a computing resource that does not satisfy the security requirements corresponding to the trusted configuration will not be able to decrypt the VM. The TVMP or VMMC are therefore sure that the VM will be launched only on a computing resource that satisfies the security requirements corresponding to the trusted configuration, even if the TVMP or VMMC does not know in advance which of the computing resources 402 of the network 401 the VM will be launched on.

(b) Prior to deploying a VM into the network 401, the VMMC or TVMP contacts the trusted third party 407 in order to get a unique secret key and a security token corresponding to a particular security profile or profiles. Next, the VMMC or TVMP uses this secret key, which can be a symmetric key, to encrypt and integrity protect a VM that it is about to be launched or provisioned in the network 401. Before the protected VM is launched on a selected computing resource, the computing resource needs to contact the trusted third party and present the received security token (for example received together with the encrypted VM). The trusted third party verifies that the selected computing resource has been booted into a trusted configuration corresponding to the security profile, or to one of the security profiles, in the token. If that is the case, the secret key (used to protect the VM) is sent protected from the trusted third party to the selected computing resource, which uses the secret key to decrypt and verify the VM for launch. The TVMP or VMMC can thus again be sure that the VM will be launched only on a computing resource that satisfies the security requirements corresponding to the trusted configuration, even if the TVMP or VMMC does not know in advance which of the computing resources 402 of the network 401 the VM will be launched on.

A detailed description of embodiments illustrating the two different solutions described above will now be given.

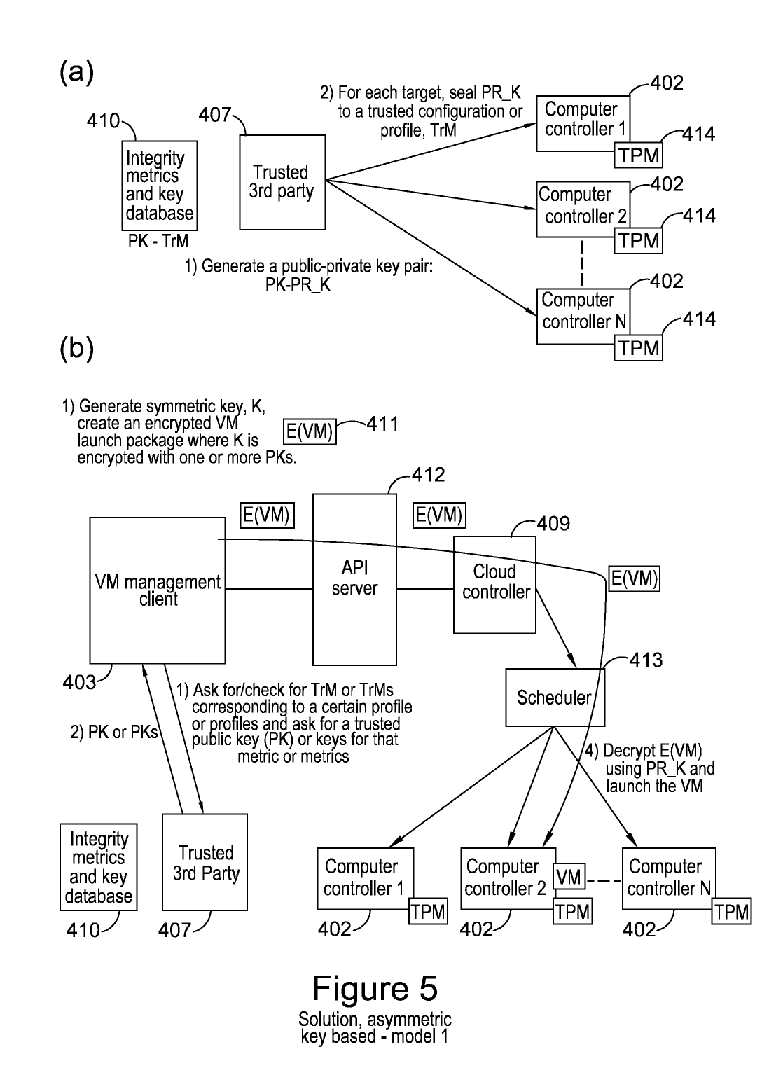

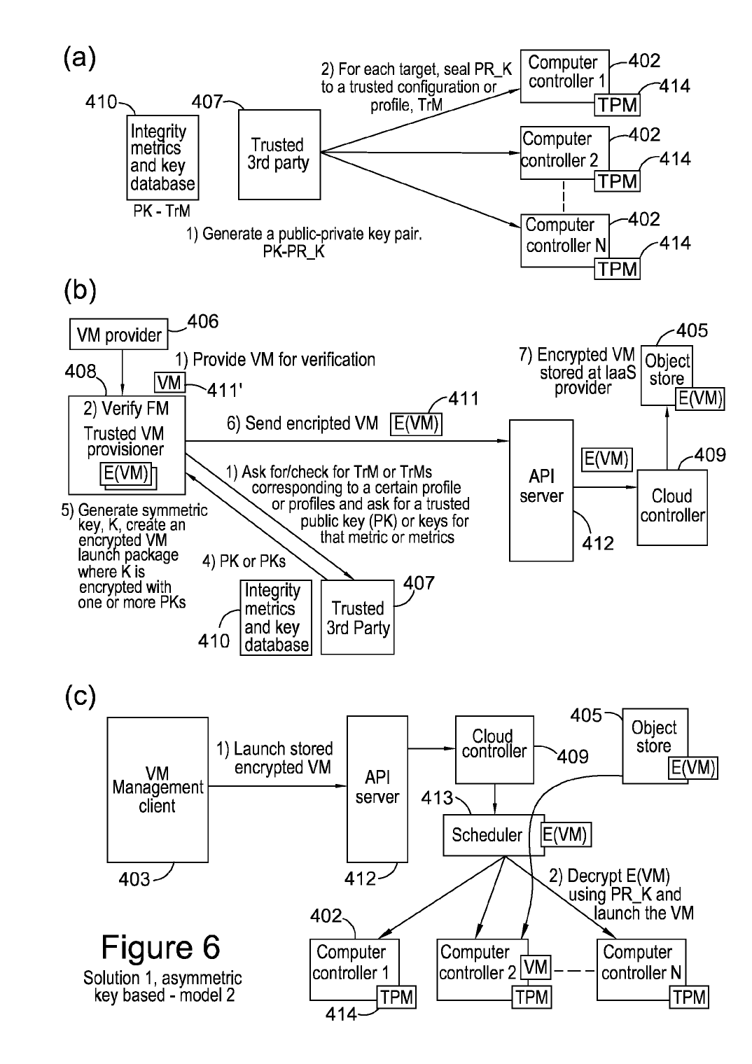

FIGS. 5(a) and (b) show a first embodiment of the present invention, and FIGS. 6(a)-6(c) show a second embodiment. The embodiment of FIGS. 5(a) and 5(b) relates to the “model 1” of the VM launch procedure as shown in FIG. 2; FIG. 5(a) shows the stages involving the trusted third party 407 in the first embodiment, and FIG. 5(b) shows the stages involving the VM Management Client (VMMC) 403 in the first embodiment. The embodiment of FIGS. 6(a)-6(c) relates to the “model 2” of the VM launch procedure as shown in FIG. 3; FIG. 6(a) shows the stages involving the trusted third party 407 in the second embodiment, FIG. 5(b) shows the stages involving the Trusted VM Provisioner 408 in the second embodiment, and FIG. 6(c) shows the stages involving the VMMC 403 in the second embodiment. These embodiments use an asymmetric key, for example a public key-private key pair.

The embodiments of FIGS. 5(a) and 5(b) and FIGS. 6(a)-6(c) are each divided into four major phases, initialisation, VM production and bundling, VM launch, and maintenance. Some of the phases differ between FIGS. 5(a) and 5(b) and between FIGS. 6(a)-6(c), as described for each phase respectively.

In the Initialisation phase a key is sealed into one or more computer controllers (in the Nova architecture) or, to use more general terminology, into one or more computing resources 402 of the network 401 of FIG. 4. We assume that a public private key pair, PK-PR_K, is generated (stage 1 of FIG. 5(a) or 6(a)) by a trusted third party 407 (for example the trusted third party 407 of FIG. 4) that communicates with an integrity metrics and key database 410. This key pair is common to a specific security profile (or security profiles), and so is shared between all computing resources in the network that adhere to the profile(s). The key is assumed to be valid to be used in the network 401 under a certain scope—for example it may be valid only for a specified time period, network etc. (The key can be sealed to any parameter or combination of parameters of the configuration of a computing resources including for example the network ID—if the key is sealed against a network ID, the computing resource will be able to access the key only while it is in the network having that network ID.)

The trusted third party 407 authenticates each computing resource 402 that is to be deployed in the system and then the private key is sealed into each computing resource (stage 2 of FIG. 5(a) or 6(a)) via the TPM (Trusted Platform Module) 414 of the computing resource 402—for example a platform sealing mechanism may be used such as, for example, the TPM standard sealing mechanisms as defined by the TCG, to seal the previously generated private key (PR_K) into all computing resources. In general a key is sealed against one security profile per sealing operation, but, if desired, the same key can be sealed to several different security profiles by using repeated sealing operations. The sealing mechanism implies that a computing resource will not be able to access the private key (PR_K) unless the computing resource is, at the time it attempts to retrieve the key, adhering to at least one specific security profile to which the private key was sealed. (As explained above, where the private key is sealed against multiple security profiles, depending on whether the key is sealed against the multiple security profiles individually or recursively a computing resource must satisfy at least one or all of the multiple security profiles in order to be able to access the private key (PR_K)). This could for example require that the computing resource must have been booted to a specific software state defined in the security profile in order for the computing resource to be able to access the key.

In FIG. 5(b) the trusted third party 407 is shown as a separate entity from the VMMC 403, and in FIG. 6(b) the trusted third party 407 is shown as a separate entity from the TVMP 408. In principle, however, the trusted third party 407 and the VMMC, or the trusted third party 407 and the TVMP 408, could be a single entity.

Note that the initialisation phase is identical between FIG. 5(a) and FIG. 6(a).

The next phase, the VM production and bundling phase, is the phase when the VM is created or obtained. In the embodiment of FIGS. 5(a) and 5(b), the VMMC 403 is itself responsible for the producing the VM, meaning that the VMMC has assembled the VM itself (or possibly has sourced the

VM from a trusted VM provider). In the embodiment of FIGS. 6(a)-(c), a VM provider 406 (such as the VM provider 406 of FIG. 4—which need not be trusted—provides the TVMP 408 (stage 1 of FIG. 6(b)) with a VM 411′ which the TVMP then verifies (stage 2 of FIG. 6(b)).

When the VMMC 403 is about to provision and launch its VM in the network 401 (FIG. 5) or the TVMP 408 prepares for provisioning of the verified VM (FIG. 6), they both first contact (stage 1, FIG. 5(b) or stage 3, FIG. 6(b)) a trusted third party 407 in order to retrieve one or more public key(s), each corresponding to a specific security profile. (In general the trusted third party contacted at this stage will be the same trusted third party that generated the public-private key pair, PK-PR_K, in the initialisation phase, but the invention does not require this.)

The trusted third party 407 returns to the VMMC 403 (FIG. 5) or TVMP 408 (FIG. 6) the public key(s), PK, (if available) corresponding to the requested security profile(s) (stage 2, FIG. 5(b) or stage 4, FIG. 6(b)).

The VMMC 403 (FIG. 5) or TVMP 408 (FIG. 6) generates a symmetric key, and prepares a VM launch package that, in general, includes an encrypted VM and a key that may be used in decrypting the encrypted VM package and that is itself protected in some way, for example is encrypted (stage 3, FIG. 5(b) or stage 5, FIG. 6(b)). For example, the VM may be encrypted with the symmetric key, and the symmetric key may then be encrypted with the public key PK supplied by the trusted third party 407, so that the VM launch package 411 includes (1) the VM encrypted with the symmetric key and (2) the symmetric key encrypted with the public key PK supplied by the trusted third party. Principles for encrypting the VM may for example follow the encryption and protection principles described in PCT/SE2011/050502 and/or U.S. Ser. No. 13/275722. In a case where the VM is protected with several public keys (corresponding to different profiles, so that the encrypted VM can be decrypted using any of multiple private keys), then a suitable symmetric encryption format is the format as specified in PCT/SE2011/050502 and U.S. Ser. No. 13/275722 except that the symmetric key is not just encrypted with one public key but is individually encrypted with all applicable public keys and so can be decrypted using any one corresponding private key. All these different encrypted keys are part of the launch package in that case.

In a further embodiment, it may be desired that only computing resources 402 that adhere to multiple security profiles can launch the VM. In that case the symmetric key is not encrypted with only a single key or is individually encrypted with different public keys, but is recursively encrypted with several public keys with the result that a computing resources must have access to all corresponding private keys in order to be able to obtain the secret symmetric key. Thus, only a computing resource that satisfies all the security profiles corresponding to the keys used to recursively encrypt the symmetric key will be able to decrypt the VM.

The VM launch package 411 is then provisioned into the network 401 by the VMMC 403 or by the TVMP 408, for example via an API server 412. In the embodiment of FIGS. 5(a) and 5(b), the VM launch package is intended for immediate launch. In the embodiment of FIGS. 6(a)-6(c), the VM launch package is sent by the TVMP 408 for storage in the network 401 (stages 6, 7 of FIG. 6(b)), for example in an object store 405.

Once the VM launch package has been provisioned into the network, it is launched in the VM launch phase. In the embodiment of FIGS. 5(a) and 5(b), the VMMC 403 sends the VM launch package 411 to the computing network 401 (which may be treated like a black box with respect to the VMMC)—his is also part of stage 3 of FIG. 5(b)—and then instructs launch of the VM, for example by instructing controller 409 of the network. A scheduler 413 of the computing network selects a computing resource 402 to run the VM and forwards the VM launch package 411 to the selected computing resource. In the embodiment of FIGS. 6(a)-6(c), the VMMC 408 asks the computing network 401 to launch a pre-stored VM launch package—stage 1 of FIG. 6(c)—for example by suitably instructing controller 409 of the network. The VM launch package is retrieved from the object store 405, and a scheduler 413 selects a computing resource 402 to run the VM and forwards the VM launch package to the selected computing resource.

Details of the way in which the scheduler 413 selects a computing resource to run the VM and forwards the VM launch package to the selected computing resource may differ from one network architecture to another, and potentially involve less or more intermediate nodes before the VM launch package finally reach the selected computing resource. However, the same general principles of the invention apply to different network architectures and to different network models.

Finally the VM launch package 411 reaches the selected computing resource 402, still containing the VM in encrypted form. The computing resource that receives the VM launch package may then, provided that it is in a trusted configuration corresponding to the security profile (or to one of the security profiles) against which the private key was sealed into the computing resource, obtain the corresponding sealed PR_K and use this to decrypt the symmetric key included in the VM package. The computing resource can then in turn use the decrypted symmetric key to decrypt the VM package, and is then able to launch the requested VM. However, if the computing resource 402 that receives the VM launch package is not in a trusted configuration corresponding to the security profile (or to one of the security profiles) against which the private key was sealed into the computing resource, it will not be able to obtain the corresponding sealed PR_K and so cannot decrypt the symmetric key included in the VM package—and so cannot decrypt and run the VM.

To reduce network traffic and related load, it may be desirable to verify that the receiving computing resource is in a state corresponding to one of the security profiles before the actual encrypted VM image is sent to the receiving computing resource. This may be done using, for example, a suitable TCG remote attestation process.

The final phase, the Maintenance phase, relates to events carried out after the VM has been launched on a computing resource of the computing network. A computer controller may need to change its software and/or its configuration after the initialisation phase above. In the event of such a change, the trusted third party needs to re-authenticate the computer controller. This may be done as described in the initialisation phase, stage 2 above, typically reusing the original PR_K. (If, in an method where the VM is stored in a object store in the network for a future launch, there is a configuration change during the time when the VM is in storage, a similar process is required—for example, in an embodiment of FIG. 5(a) and 5(b) or 6(a)-(c), the key that was used to encrypt the stored VM needs to be re-encrypted).

However, if the software and/or configuration change is such that the computing resource no longer matches the security profile (or one of the security profiles) to which the original PR-K is bound, the key pair needs to change accordingly. At least one new security profile is defined, and a previously generated key pair corresponding to this profile is retrieved (if one exists), or (for a completely new security profile) a new key pair is generated. The private key is then sealed into the computing resource as described above.

Finally, if after the change the computer controller no longer matches any security profile trusted by the user, the computer controller is no longer able to retrieve the private key sealed into the computer controller, and so is not able to decrypt the VM.

Note that the maintenance step is identical between the embodiment of FIGS. 5(a) and 5(b) and the embodiment of FIGS. 6(a)-(c).

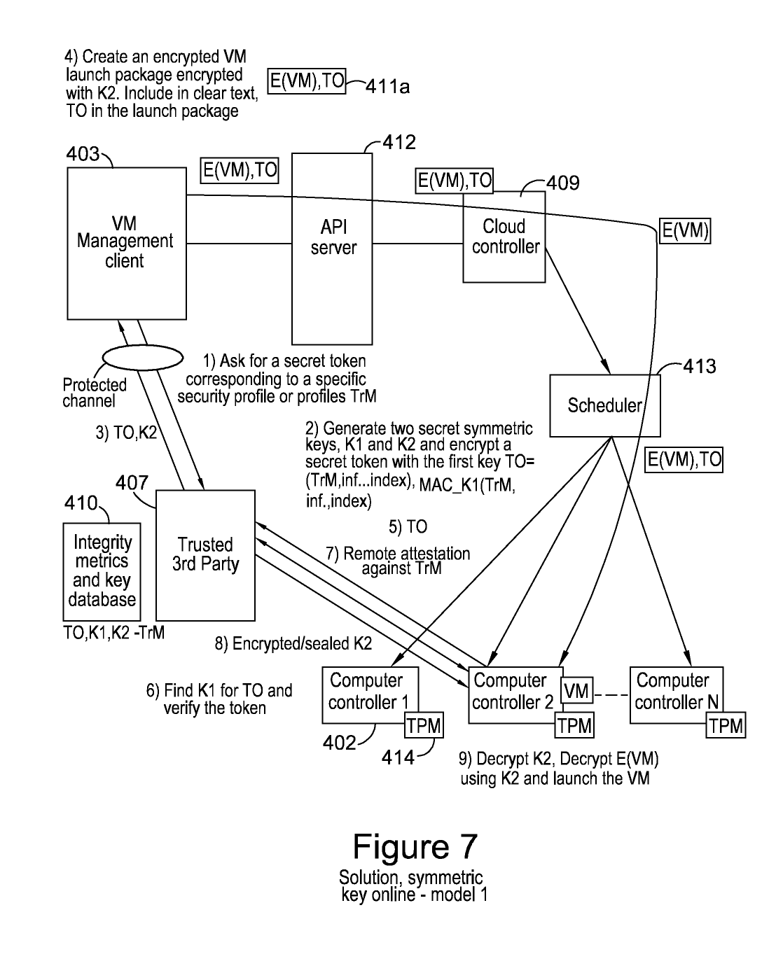

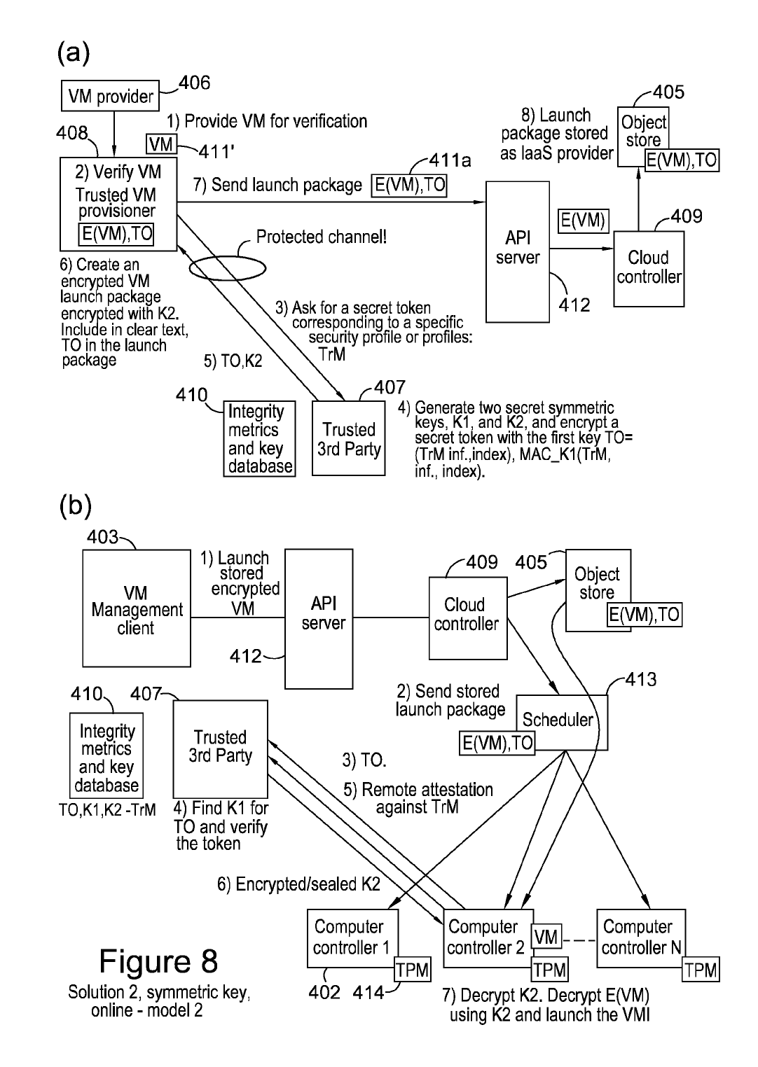

FIG. 7 shows a third embodiment of the invention, and FIGS. 8(a)-8(b) show a fourth embodiment. The embodiment of FIG. 7 relates to the “model 1” of the VM launch procedure as shown in FIG. 2, and the embodiment of FIGS. 8(a)-8(b) relates to the “model 2” of the VM launch procedure as shown in FIG. 3; FIG. 8(a) shows the stages involving the TVMP 408 (which acts as the VM provisioner) in the fourth embodiment, and FIG. 8(b) shows the stages involving the VMMC 403 in the fourth embodiment. The third and fourth embodiments use a symmetric key.

In the third embodiment of FIG. 7, a trusted third party 407 that communicates with an integrity metrics and key database 410, such as the trusted third party 407 of FIG. 4, offers the VMMC 403 a key generation service. At stage 1 of FIG. 7 the VMMC contacts the trusted third party and asks for a key and a security token, TO, corresponding to a particular security profile or profiles for a computing resource that is to be permitted to run a VM. The request is preferably made over a protected (authenticated and encrypted) secure channel.

Upon receiving the request sent at stage 1, the trusted third party 407 generates, at stage 2 of FIG. 7, two symmetric keys, K1 and K2, and a security token. The token corresponds to the particular security profile or profiles specified by the VMMC in stage 1. For example, the token may be generated based on the security profile(s), for example according to:
TO=(TrM, inf.,index), MAC_K1 (TrM, inf., index).

In this, TrM is a parameter describing the security profile or profiles to which the token corresponds. The “inf.” field can contain information such as the length of time for which the token will be valid time. The MAC is a message authentication code calculated using the key K1 which as will become clear, can be considered as a “secret key”. The index value is used by the third party to be able to verify the token in a subsequent stage, as described below.

At stage 3 of FIG. 7 the TO generated in stage 2 is sent together with the key K2 (that is, not the “secret key” but the other key generated by the third party) to the VMMC 403, again preferably over a protected secure return channel.

At stage 4 of FIG. 7 the VMMC 403 prepares a VM launch package 411a including a VM image. The VM package is encrypted using the key K2, and the VM launch package 411a includes the encrypted VM package and the token TO. The token TO is included in clear (that is, not encrypted) in the VM launch package 411a, but other components of the VM launch package is/are encrypted using the key K2. The VMMC then provisions the VM launch package 411a into the network 401, for example via an API server 412, and a controller 409 and/or scheduler 413 in the network uses a scheduling mechanism to find a suitable free computing resource 402 for the VM. It may alternatively also be the case that the VM launch package is sent to the network for later deployment, and is stored in an object store (not shown in FIG. 7) and is scheduled at a later time by a scheduling mechanism in the network 401.

Thus, at some time after the VM launch package is sent to the network 401, a computing resource 402 in the network receives the VM launch package 411a that includes the encrypted VM package and the token TO (not encrypted), or (as described below) receives at least the token TO. After having received at least the token TO of the launch package, the selected computing resource connects to the trusted third party 407 and sends the received token TO to the trusted third party at stage 5 of FIG. 7. (The computing resource may for example determine the identity of the trusted third party from the token TO.)

At stage 6 of FIG. 7 the trusted third party 407 verifies the token TO that the trusted third party has received from the selected computing resource. In a preferred embodiment the trusted third party 407 may use the index in the token TO to find in its internal database the symmetric key, K1, that was used to integrity protect the TO. The trusted third party then uses the key K1 to verify the TO and to obtain the TrM value(s) and to verify all fields in the token TO that the trusted third party has received.

Assuming that the token is satisfactorily verified, at stage 7 of FIG. 7 the trusted third party 407 communicates with the Trusted Platform Module (TPM) of the computing resource to make a remote attestation against the computing resource 402 from which it has received the token TO in order to verify that the computing resource 402 is running in a state corresponding to a security profile, or one of the security profiles, indicated by the TrM value obtained in stage 6. The trusted third party may for example use a remote attestation procedure.

If the remote attestation in stage 7 is satisfactory, the trusted third party 407 then sends the key K2 to the computing resource at stage 8. The trusted third party preferably protects the key in some way, for example by encrypting the key K2 using a secure channel or a sealing mechanism, and sends the protected key K2 to the computing resource.

In a case where the selected computing resource received only the token TO at stage 5 and did not receive the encrypted VM package at stage 5, the encrypted VM is now provided to the selected computing resource.

At stage 9, the selected computing resource 402 uses the received symmetric key, K2, to decrypt the encrypted VM package, and is then able to launch the VM.

If however the remote attestation in stage 7 is unsatisfactory—that is if the remote attestation does not show that the selected computing resource is running in a configuration corresponding to the security profile (or to one of the security profiles)—the trusted third party 407 does not send the key K2 to the computing resource. The selected computing resource cannot then decrypt the VM. Thus, this embodiment again ensures that the VM cannot be launched on a computing resource that is not running is not in a trusted configuration corresponding to the security profile (or to one of the security profiles) specified by the VMMC at stage 1.

FIG. 8(a) and FIG. 8(b) show a fourth embodiment of the invention. This fourth embodiment corresponds generally to the third embodiment in that it uses a symmetric key, but in the fourth embodiment the VM launch package is prepared by a TVMP 408 rather by a VMMC as in the third embodiment. The method of the fourth embodiment has two main phases, a provisioning phase shown in FIG. 8(a) and a launch phase shown in FIG. 8(b).

In the Provisioning phase, at stage 1 of FIG. 8(a) a VM provider 406 such as VM provider 406 of FIG. 4 provides the trusted VM provisioner (TVMP) 408 with a VM. Note that the VM provider 406 may be the same entity as the TVMP 408. The VM provider 406 may also be the same entity as the provider of the network 401, but, in a case where the network provider is not trusted, the TVMP 408 is preferably a separate entity from the network provider since the network provider cannot be trusted to be the verifier of the VMs. (If the network provider is trusted, one entity may in principle act as the VM provider, the TVMP and the network provider.)

At stage 3 of FIG. 8(a) the TVMP 408 preferably verifies the provided VM to have certain specified properties.

A trusted third party 407 offers to the TVMP a key generation service (note that, although the trusted third party 407 and the TVMP 408 are shown as separate entities in FIGS. 4 and 8(a), the trusted third party and the TVMP may alternatively be the same entity). At stage 3 of FIG. 8(a) the TVMP 408 contacts the trusted third party 407 and asks for a key and a security token, TO, corresponding to a particular security profile or profiles for a computing resource that is to be able to run the VM. The request is preferably sent over a protected (authenticated and encrypted) secure channel.

In a case where the trusted third party and the TVMP are the same entity, and all communication is done within an internal, properly protected communication path, the level of security of the protected secure channel may be lower to reflect these circumstances.

Upon receiving the request sent at stage 3, the trusted third party 407 generates, at stage 4 of FIG. 8(a), two symmetric keys, K1 and K2, and a security token TO. The token corresponds to the particular security profile or profiles specified by the TVMP in stage 3. For example, the token may be generated based on the security profile(s), for example according to:
TO=(TrM, inf., index), MAC_K1 (TrM, inf., index).

In this, TrM is a parameter describing the security profile or profiles to which the token corresponds. The “inf.” field can contain information such as the length of time for which the token will be valid time. The MAC is a message authentication code calculated using the key K1 which as will become clear, can be considered as a “secret key”. The index value is used by the third party to be able to verify the token in a subsequent stage, as described below.

At stage 5 of FIG. 7 the token TO generated in stage 4 is sent together with the key K2 (that is, not “secret key” but the other key generated by the third party) to the TVMP 408, again preferably over a protected secure return channel.

At stage 6 of FIG. 7 the TVMP 408 prepares a VM launch package 411a including a VM image. The VM package is encrypted using the key K2, and the VM launch package includes the encrypted VM package and the token TO. The token TO is included in clear (that is, not encrypted) in the VM launch package, but other components of the VM launch package is/are encrypted using the key K2.

The VM launch package is provisioned at stage 7 to the network 401, and at stage 8 is stored in the network (in object store 405) for later launching.

In the launch phase, a VMMC 403 such as the VMMC 403 of FIG. 4, sends to the network controller 409 a command to launch a VM stored in the network 401 at stage 1 of FIG. 8(b). In response to this command, at stage 2 of FIG. 8(b) a scheduler 413 of the network 401 selects an eligible computing resource 402 and either the entire launch package, or just the token TO, is sent to the selected computing resource.

At stage 3 of FIG. 8(b), the selected computing resource 402 connects to the trusted third party 407, and sends the received TO to the trusted third party. The computing resource may for example, determine the identity of the trusted third party from the token TO

At stage 4 of FIG. 8(b) the trusted third party 407 verifies the token TO that the trusted third party has received from the selected computing resource. In a preferred embodiment the trusted third party 407 may use the index in the token TO to find in its internal database the symmetric key, K1, that was used to integrity protect the token TO. The trusted third party then uses the key K1 to verify the TO and to obtain the TrM value(s) and to verify all fields in the token TO.

Assuming that the token is satisfactorily verified, at stage 5 of FIG. 8(a) the trusted third party makes a remote attestation against the computing resource 402 in order to verify that the computing resource is running in a state corresponding to a security profile, or one of the security profiles, indicated by the TrM value obtained in stage 4. The trusted third party 407 may for example use a remote attestation procedure.

If the remote attestation in stage 5 is satisfactory, the trusted third party 407 then sends the key K2 to the computing resource 402 at stage 6 of FIG. 8(b). The trusted third party preferably protects the key in some way, for example by encrypting the key K2 using a secure channel or a sealing mechanism, and sends the protected key K2 to the connected computer controller.

In a case where the selected computing resource did not receive the encrypted VM at stage 2, the encrypted VM is now provided to the selected computing resource.

At stage 7 of FIG. 8(b), the selected computing resource 402 uses the received symmetric key, K2, to decrypt the encrypted VM, and is then able to launch the VM.

If however the remote attestation in stage 5 is unsatisfactory, that is the remote attestation does not show that the selected computing resource is running in a configuration corresponding to the security profile (or to one of the security profiles), the trusted third party does not send the key K2 to the computing resource. The selected computing resource cannot then decrypt the VM. Thus, this embodiment again ensures that the VM cannot be launched on a computing resource that is not running is not in a trusted configuration corresponding to the security profile (or to one of the security profiles) specified by the TVMP.

It will be understood that the invention is not limited to the first to fourth embodiments described with reference to FIGS. 5(a) to 8(b) above.

For example, in one modification, which may be applied to either the third embodiment of FIG. 7 or to the fourth embodiment of FIGS. 8(a) and 8(b), the key K2 may be encrypted, using K1, as part of the token TO by the trusted third party 407. In this modified embodiment, when the selected computing resource 402 sends the token TO to the trusted third party (stage 5 of FIG. 7 or stage 3 of FIG. 8(b)) the key K2 is decrypted by the trusted third party as part of the process of verifying the token TO and performing attestation of the computing resource. This means that the key K2 does not need to be stored in the trusted third party.

In another alternative modification, which may be applied to either the third embodiment of FIG. 7 or to the fourth embodiment of FIGS. 8(a) and 8(b), K2 is not generated by the trusted third party, but by the VMMC 403 (FIG. 7) or the TVMP 408 (FIGS. 8(a) and 8(b)). The VM launch package thus includes the VM encrypted with K2, the token TO (not encrypted) and the key K2 which is protected in some way, for example is encrypted with the public key of the trusted third party. When the VM launch package is received at a selected computing resource, the key K2 then needs to be sent to the trusted third party by the computing resource to be decrypted—and the trusted third party only carries out the process of decrypting the key K2 and sending the decrypted key to the computing resource if the verification of the token TO and the remote attestation of the computing resource are both successful.

The present invention provides a number of advantages, including the following:
The first and second embodiments are almost completely transparent to the IaaS architecture (or other network architecture) provided that the network infrastructure is able to handle and schedule encrypted VMs and not only clear text VMs. This comes at the cost of additional requirements with respect to the required initialisation and maintenance procedures. (The third and fourth embodiments require a network architecture that can provide a trusted third party with which a computing resource can communicate.)
In all embodiments, there is no dependence on any trust in the network provider as such (only in the computing resources of the network).
According to the third and fourth embodiments the requirement for shared trust between all computing resources for a given security profile is eliminated. On the other hand these embodiments are dependent on an online trusted third party, so that the selected computing resource can contact the trusted third party as described at state 5 of FIG. 7 or stage 3 of FIG. 8(b). No online connection is required for the trusted third party in the first and second embodiments since it is only the VMMC or TVMP that needs to communicate with the trusted third party in these embodiments.
One advantage of the third and fourth embodiments compared to the solution already presented in PCT/SE2011/050502, is that the burden of verifying the target platform is completely moved to a third party. Hence, the client is released from making direct verification of the target prior to launch. This also allows the VMMC to send the launch package without knowing which computer controller that actually will be scheduled to run the VM. Also, the verification may be done after the

VM has reached the target computer controller and not during VM transfer, which make the verification process more flexible. On the other hand this may delay the VM launch at the computing resource.
The second and fourth embodiments addresses the common scenario in which a VMMC would like to deploy a VM image provided by another party, e.g. by an IaaS provider. Instead of as in the common case, where the VMMC simply has to trust the VM provider to provide a secure image, the second and fourth embodiments enable the VMMC to have established trust in the security of the VM image.

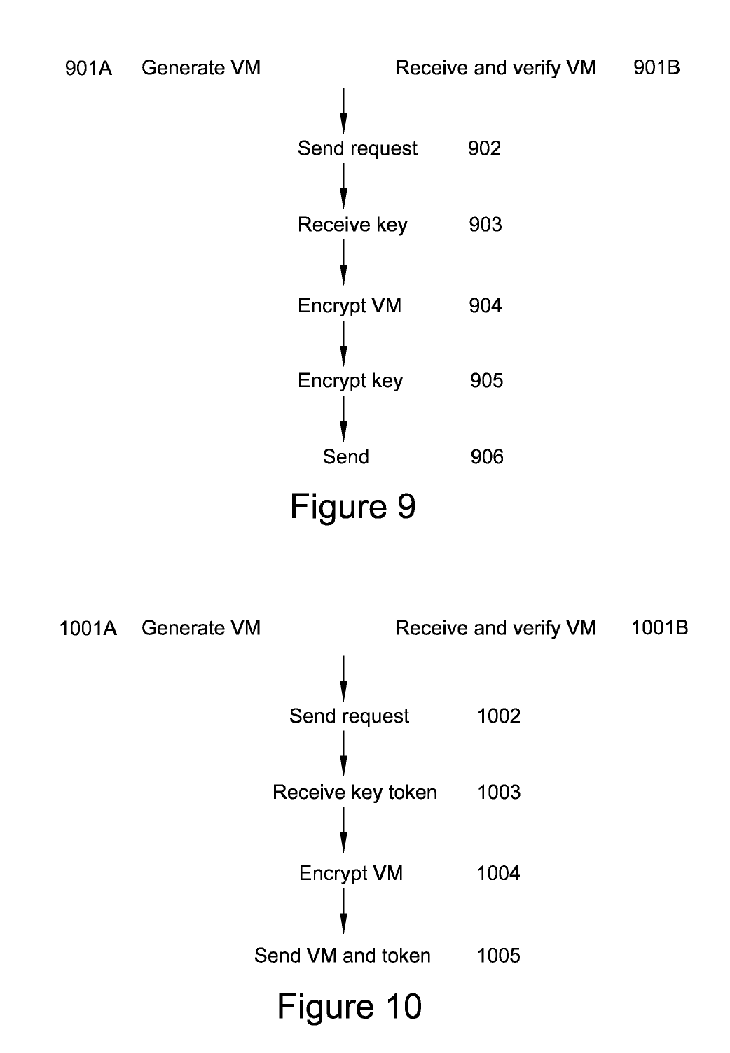

FIG. 9 is a block flow diagram showing principal steps carried out by the network entity 403 in a method as shown in FIG. 5(b) or 6(b) of the application. Initially, the network entity 403 generates a VM at 901A (if the entity 403 is a VMMC). Alternatively, if the entity 403 is a TVMP, it may receive, at 901B, a VM from a VM provider 406, and will optionally verify the received VM.

The network entity (eg the VMMC or TVMP) then sends a request to a trusted third party 407 for one or more keys each corresponding to one or more desired security profiles. This is stage 902 of FIG. 9. For example, the network entity may request one or more trusted public keys PK corresponding to one or more desired security profiles.

At stage 903, the network entity receives the requested key(s) from the trusted third party 406.

The network entity then encrypts the VM, at 904 of FIG. 9. This may be done by the network entity generating a symmetric key, and using this to encrypt the VM.

Next, at 905 of FIG. 9 the network entity encrypts the key that was used in stage 904 to encrypt the VM. For example, the network entity may use a public key received from the trusted third party at 903 to encrypt, at 905, the symmetric key used at 904 to encrypt the VM.

The network entity then puts the encrypted VM and the encrypted key into a VM launch package and sends, at 906 of FIG. 9, the VM launch package to the network 401.

FIG. 10 illustrates the principal steps carried out by the network entity 403 in a method according to FIG. 7 or FIG. 8(a) of the present application. Initially, the network entity 403 may, if it is a VMMC, generate a VM at 1001A. Alternatively, if the network entity 403 is a TVMP, it may at 1001B of FIG. 10 receive a VM from a separate VM provider 406, and optionally verify the received VM.

At 1002 of FIG. 10, the network entity (eg the VMMC or TVMP) sends a request to a trusted third party 407 for a token corresponding to a security profile or security profiles. At 1003 of FIG. 10 the network entity receives the token and a key (K2) from the trusted third party 407.

At 1004 of FIG. 10 the network entity encrypts the VM using the key K2, to create an encrypted VM package.

The VMMC or TVMP then prepares a VM launch package that includes the token (in clear) and the encrypted VM package prepared at 1004 of FIG. 10. The VM launch package is then sent to the network 401, at 1005 of FIG. 10.

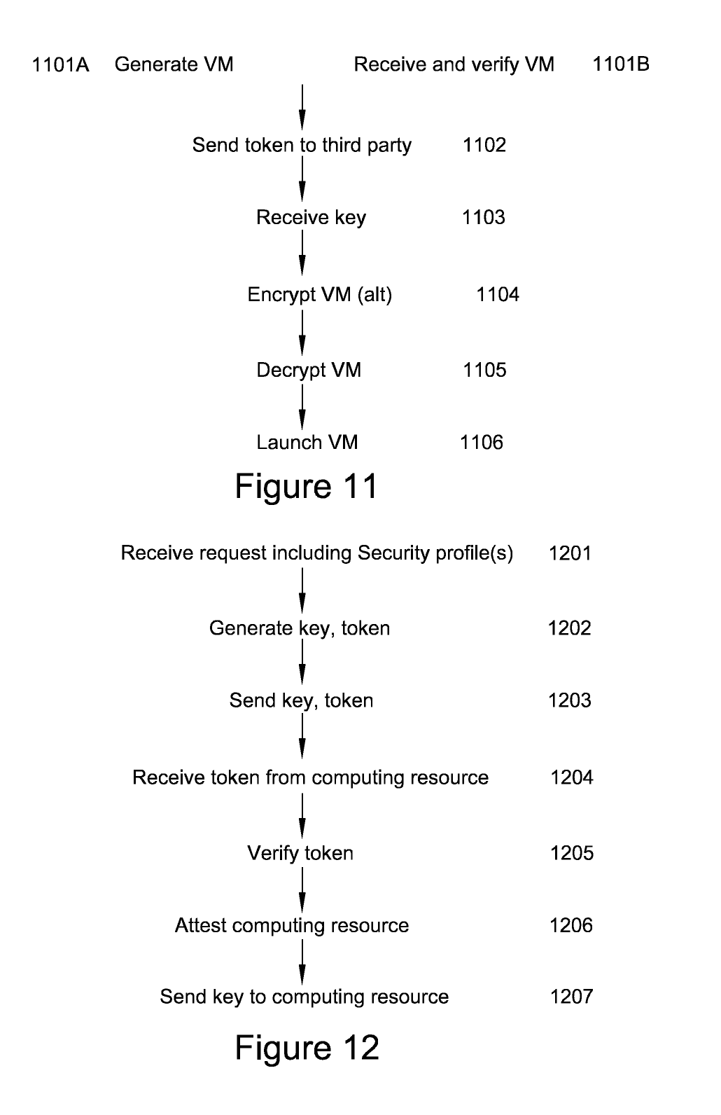

FIG. 11 is a schematic block flow diagram showing the principal features carried out by a computing resource in a method as shown in FIG. 7 or FIG. 8(b) of the application. Initially, the computing resource receives a VM launch package that contains an encrypted VM package and a token TO in clear—1101A of FIG. 11. Alternatively, the selected computing resource may initially receive only the token TO, as shown at 1101B of FIG. 11.

The computing resource determines the identity of the trusted third party that generated the received token TO, and at 1102 the computing resource sends the token TO to the trusted third party.

When the third party receives the token TO it will, as described above, verify the token and then perform remote attestation against the computing resource to determine that the computing resource is currently in a configuration that satisfies the security profile, or at least one of the security profiles, indicated by the token. Provided that the verification of the token and the attestation of the computing resource are both satisfactory, the computing resource will receive the key used to encrypt the encrypt VM package at 1103 of FIG. 11.

If the computing resource initially received only the token TO as indicated at 1101B, the computing resource now receives the encrypted VM package at 1104. (If the computing resource received the complete VM launch package at 1101A, stage 1104 may be omitted.) (If the computing resource is only sent the token initially, the computing resource may inform the scheduler or controller that it had received the key, and the scheduler/controller would then forward the encrypted VM package to the computing resource.)

The computing resource is then able to decrypt the encrypted VM package using the key received from the trusted third party at 1105, and can then launch the VM at 1106.

FIG. 12 is a schematic block flow diagram showing the principal steps carried out at a trusted third party in the method of FIG. 7 or FIG. 8(a) of the present invention.

Initially, at 1201 the trusted third party receives a request from a network entity 403 for a token. The network entity 403 may for example be a VMMC (as in FIG. 7) or a TVMP (as in FIG. 8(a)).

In response to the request, the third party generates a token TO at 1202 of FIG. 12. The token is generated so as to correspond to the security profile(s) indicated in the request from the network entity. The token may optionally be also generated based on a first key K1 that can subsequently be used to verify the token TO. The trusted third party may also generate a further key K2.

At 1203 of FIG. 12, the trusted third party sends the token TO and the key K2 to the network entity that requested the token.

The network entity then incorporates the token into a VM launch package that is launched into the network 401 as described above. Also described above, a computing resource of the network is selected to launch the VM included in the VM launch package, and the VM launch package or at least the token TO is sent to that computing resource. Thus, at some later stage the trusted third party receives, at 1204, the token from the computing resource that has been selected to launch the VM. The trusted third party verifies the token at 1205, for example by use of the key K1 used in generation of the token. The third party then, at 1206, carries out a remote attestation of the computer resource, to determine whether the computing resource is currently in a trusted configuration that corresponds to the security profile(s) identified by the token.

Provided that the token is satisfactorily verified at 1205, and that the attestation of the computing resource at 1206 shows the resource is in a trusted configuration, the trusted third party then sends, at 1207 to the computing resource a key that the computing resource can use to decrypt the encrypted VM package, for example the key K2.

As noted above, the key K2 may be stored in the trusted third party. In this case the trusted third party retrieves the stored key K2 and sends it to the computing resource once the token has been satisfactorily verified, and the attestation of the computing resource shows the resource is in a trusted configuration. Alternatively, the trusted third party may have encrypted the key as part of the token when the token was generated at 1202—in this case the trusted third party can recover the key K2 from the token and send the key to the computing resource at 1207—and there is no need for the trusted third party to store the key K2.

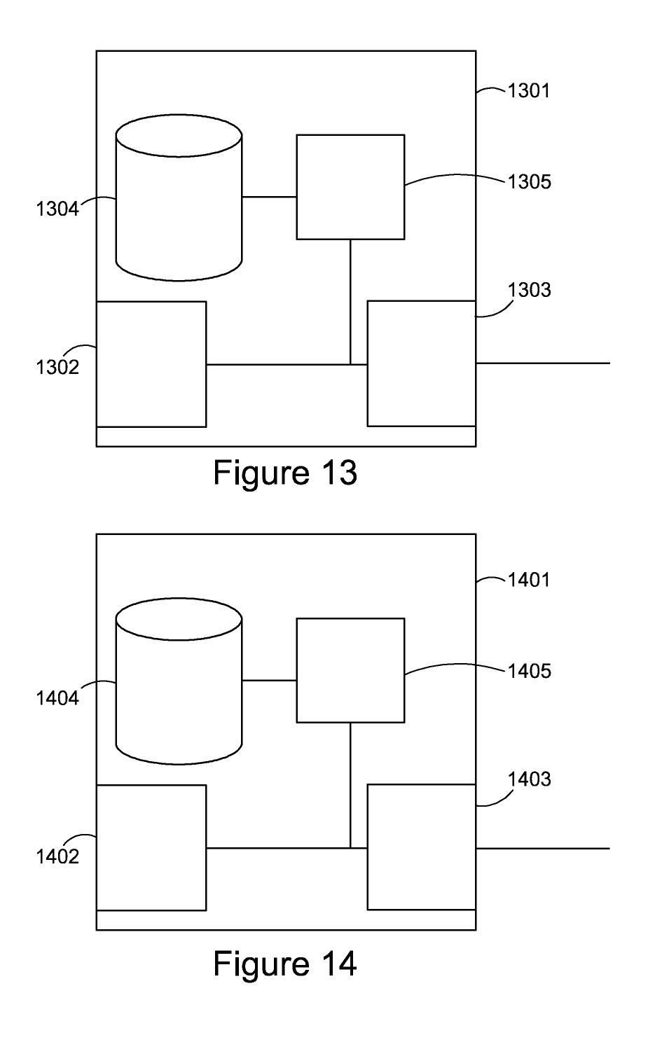

FIG. 13 is a schematic block diagram showing principal components of a network entity of the present invention. The network entity 1301 has an input interface 1302 and an output interface 1303. The network entity further includes a processor 1305, and a memory 1304 storing inter alia, programming instructions for execution for the processor 1305. The network entity 1301 may for example be a VMMC or TVMP 403, in which case the memory 1304 stores instructions that, when executed by the processor 1305, cause the network entity to carry out a method of, for example, FIG. 9 or FIG. 10. The input and output interfaces 1302, 1303 allow the network entity to communicate with one or more of the network 401 of FIG. 4, a user 404, a VM provider 406 or a trusted third party 407.

Alternatively, the network entity 1301 of FIG. 13 may be a trusted third party such as the trusted third party 407 of FIG. 4. In this case, the memory 1304 may store instructions that, when executed by the processor, cause network entity to carry out a method as in FIG. 12. In this case, the input and output interfaces 1302, 1303 allow the network entity to communicate with a VMMC or TVMP, and with a computing resource.

FIG. 14 is a schematic block diagram showing principal components of a computing resource according to the present invention. The computing resource has an input interface 1402 and an output interface 1403, and also has a processor 1405 and a memory 1404 for storing, inter alia, instructions for execution by the processor 1405.

The computing resource 1401 may receive a VM launch package, or a token TO at the input interface 1402. The processor may then cause the computing resource to carry out a method of the invention, for example a method as shown in FIG. 11. The computing resource 1402 may communicate with the trusted third party by means of the output interface 1403 and the input interface 1402.

1. A method of provisioning a virtual machine (VM) to a computing network, the method comprising:
at a VM manager or provisioner, encrypting a virtual machine using a first key bound to a security profile indicative of one or more security requirements that a computing resource of the computing network must satisfy in order to be able to decrypt the VM; and
sending the encrypted VM from the VM manager or provisioner to the computing network.

2. A method as claimed in claim 1 wherein the VM manager or provisioner encrypts the virtual machine using a second key, and encrypts the second key using the first key.

3. A method as claimed in claim 1 wherein the VM manager or provisioner obtains the first key from a trusted key provider in response to the VM manager or provisioner sending a request including the desired security profile to the trusted key provider.

4. A method as claimed in claim 1 wherein the VM manager or provisioner generates the first key.

5. A method of provisioning a virtual machine (VM) to a computing network, the method comprising:
at a VM manager or provisioner, encrypting a virtual machine using a key; and
sending, from the VM manager or provisioner to the computing network, the encrypted VM and a token corresponding to a security profile indicative of one or more security requirements that a computing resource of the computing network must satisfy in order to be able to decrypt the VM.

6. A method as claimed in claim 5 wherein the VM manager or provisioner obtains the key and the token from a trusted key provider in response to the VM manager or provisioner sending a request including the desired security profile to the trusted key provider.

7. A method as claimed in claim 5 wherein the VM manager or provisioner generated the key and the token.

8. A method as claimed in claim 7 and further comprising the VM manager or provisioner
receiving the token from a computing resource;
determining whether the computing resource satisfies the security requirement(s) indicated by security profile to which the token corresponds; and
if the computing resource satisfies the security profile associated with the token, sending the key to the computing resource.

9. A method as claimed in claim 5 and further comprising the VM manager or provisioner creating the VM.

10. A method as claimed in claim 1 and further comprising the VM manager or provisioner receiving the VM from a VM provider.

11. A method as claimed in claim 5 wherein the security profile defines a set of target computing resources.

12. A method of activating a virtual machine (VM) to a computing network, the method comprising, at a computing resource of the computing network:
receiving a token corresponding to a security profile indicative of one or more security requirements that the computing resource must satisfy in order to be able to decrypt the VM;;
identifying, using the token, a key provider and sending the token to the key provider;
if the computing resource satisfies the security profile, receiving a key from the key provider; and
using the received key, decrypting the VM at the computing resource.

13. A method as claimed in claim 12 further comprising launching the VM on the computing resource.

14. A method as claimed in claim 12 and comprising the computing resource -receiving the VM with the token.

15. A method as claimed in claim 12 and comprising the computing resource receiving the VM after the computing resource has received the key.

16-23. (canceled)

24. A network entity configured to provision a virtual machine (VM) to a computing network, the network entity comprising a processor and memory storing programming instructions that, when executed by the processor, cause the network entity to:
encrypt a virtual machine using a first key; and
send, from the network entity to the computing network, the encrypted VM and a token corresponding to a security profile indicative of one or more security requirements that a computing resource of the computing network must satisfy in order to be able to decrypt the VM.

25. A network entity as claimed in claim 24 wherein the network entity is configured to send a request including the desired security profile to a trusted key provider to thereby obtain the key and the token.

26. A network entity as claimed in claim 24 wherein the network entity is configured to generate the key and the token.

27. A network entity as claimed in claim 26 and further configured to:
receive the token from a computing resource;
determine whether the computing resource satisfies the security requirement(s) indicated by security profile to which the token corresponds; and
if the computing resource satisfies the security profile associated with the token, send the key to the computing resource.

28. A network entity as claimed in claim 24 and further configured to create the VM.

29. A network entity as claimed in claim 24 and further configured to receive the VM from a VM provider.

30. A network entity as claimed in claim 24 wherein the security profile defines a set of target computing resources.

31-38. (canceled)
